(19) United States
(12) Patent Application Publication
(10) Pub. No.: US 2015/0169177 A1
(43) Pub. Date: Jun. 18, 2015

(54) CLASSIFYING PARTICULAR IMAGES AS PRIMARY IMAGES

(71) Applicant: GOOGLE INC., (US)

(72) Inventors: Chao Zhao, Shanghai (CN); Yanlai Huang, Shanghai (CN)

(73) Assignee: GOOGLE INC., Mountain View, CA (US)

(21) Appl. No.: 13/796,608

(22) Filed: Mar. 12, 2013

Related U.S. Application Data
(60) Provisional application No. 61/731,387, filed on Nov. 29, 2012.

(51) Int. Cl. G06F 3/0481

(52) U.S. Cl. CPC G06F 3/04817

(57) ABSTRACT

Methods, systems, and apparatus, including computer programs encoded on computer storage media, for identifying a plurality of web page images in a target web page; identifying a plurality of hyperlinks in other web pages, wherein each of the hyperlinks (i) links to the target web page and (ii) includes a respective image tag for a respective thumbnail image; determining a visual similarity score for each of the plurality of web page images with reference to the thumbnail images; identifying a first web page image in the plurality of web page images that has a highest visual similarity score with reference to the thumbnail images that satisfies a minimum similarity threshold; and labeling the first web page image as a primary image for the target web page.

### CROSS-REFERENCE TO RELATED APPLICATIONS

This application claims the benefit under 35 U.S.C. §119(e) of U.S. Provisional Application Ser. No. 61/731,387, filed on Nov. 29, 2012 entitled “CLASSIFYING PARTICULAR IMAGES AS PRIMARY IMAGES,” the entirety of which is hereby incorporated by reference.

### BACKGROUND

This specification relates to classifying particular images in web pages as primary images.

Web pages include content, e.g., text and images, that can be accessed through a web browser or other software and displayed on a display device of any kind of computer. Web pages can provide navigation to other web pages or particular content in other web pages using hyperlinks that link to the other web pages.

### SUMMARY

This specification describes how a system can classify a particular image on a web page as being a primary image for the web page.

The system can identify an image on the web page that is sufficiently similar to, and most similar to, thumbnail images in links to the web page, and classify the identified images as a primary image on the web page.

Alternatively, the system can identify an image on the web page that is at a location in the web page defined by a primary object path for the web page, and classify the identified images as a primary image on the web page.

In general, one innovative aspect of the subject matter described in this specification can be embodied in methods that include the actions of identifying a plurality of web page images in a target web page; identifying a plurality of hyperlinks in other web pages, wherein each of the hyperlinks (i) links to the target web page and (ii) includes a respective image tag for a respective thumbnail image; determining a visual similarity score for each of the plurality of web page images with reference to the thumbnail images; identifying a first web page image in the plurality of web page images that has a highest visual similarity score with reference to the thumbnail images that satisfies a minimum similarity threshold; and labeling the first web page image as a primary image for the target web page.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. Determining a visual similarity score for each of the plurality of web page images with reference to the thumbnail images includes: determining for each web page image a similarity value with respect to each thumbnail image, wherein the similarity value represents a degree of visual similarity between the web page image and the thumbnail image; and determining the visual similarity score for the web page image from the similarity values for the web page image with reference to the thumbnail images. Determining the visual similarity score for the web page image from the similarity values for the web page image with reference to the thumbnail images includes: selecting as the visual similarity score a median value of the similarity values, a mean of the similarity values, or a lowest similarity value of the similarity values.

The method further includes determining that the thumbnail images are all visually similar to each other. The method further includes determining that the thumbnail images are all identical; where determining a visual similarity score for each of the plurality of web page images with reference to the thumbnail images includes: determining, for each web page image, a value of a visual similarity function applied to the web page image and one of the thumbnail images. Determining that the thumbnail images are all visually similar to each other includes determining that all of thumbnail images are identical to one another.

Determining that the thumbnail images are all visually similar to each other includes determining that none of the respective similarity values corresponding to the thumbnail images are less than a predetermined threshold. Determining that the thumbnail images are all visually similar to each other includes determining that all but a predetermined percentage of the thumbnail images are identical to one another. Determining that the thumbnail images are all visually similar to each other includes determining that all but a predetermined percentage of the thumbnail images are within a threshold similarity of each other.

In general, one innovative aspect of the subject matter described in this specification can be embodied in methods that include the actions of identifying in a web site a plurality of web pages that each have an image labeled as the primary image of the respective web page; identifying a respective object path of each of the primary images, each object path being a Document Object Model path that defines a location of the corresponding primary image in the respective web page; defining a most frequently occurring object path among the identified object paths as the primary image path for the web site; identifying in the web site a first web page that has no image labeled as the primary image of the first web page and that does have a first image identified in the first web page by the primary image path; and labeling the first image as the primary image for the first web page.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. Labeling the first image as the primary image for the first web page includes identifying, in an index, the first image as a primary image for the first web page. Defining a most frequently occurring object path among the identified object paths as the primary image path for the web site includes identifying an object path that occurs more frequently than the other identified object paths combined. Defining a most frequently occurring object path among the identified object paths as the primary image path for the web site includes identifying an object path that occurs with at least a predetermined threshold frequency.

The subject matter described in this specification can be implemented in particular embodiments so as to realize one or more of the following advantages. A search engine can display a primary image for a web page identified by a search result as part of the search result information presented to a user. A search engine can add a boost to a ranking score of a primary image that has been identified as a search result when ranking the image relative to other images. The primary image for a web page can be used to provide a visual representation of the web page, e.g., by using the primary image to represent a news article.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment depicting hyperlinks in web pages that link to a web page and also include an image tag for a thumbnail image.

FIG. 2 is a block diagram of an example index describing data collected by a system while crawling a web corpus.

FIG. 3 is a flow diagram of an example process for identifying a primary image in a web page.

FIG. 4 is a flow diagram of another example process for identifying a primary image in a web page.

Like reference numbers and designations in the various drawings indicate like elements.

### DETAILED DESCRIPTION

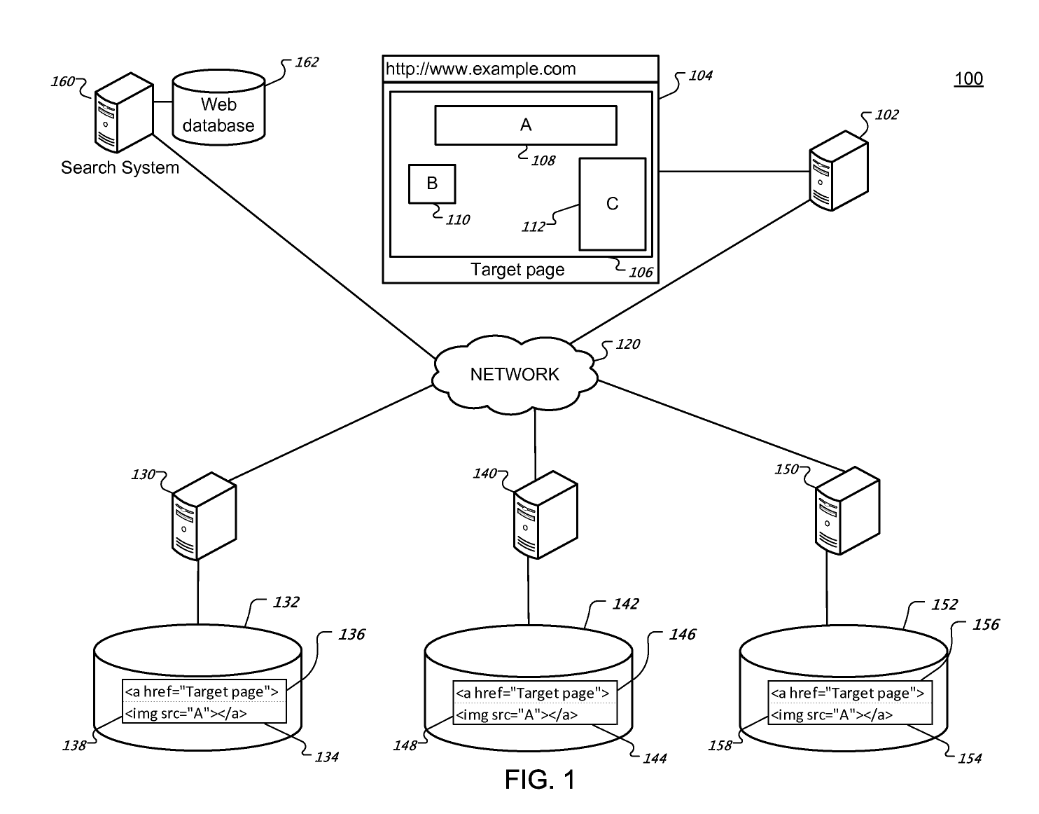

FIG. 1 is a block diagram of an example environment 100 depicting hyperlinks 136, 146, and 156 in web pages 134, 144, and 154. The hyperlinks both (i) link to a target web page 106 and (ii) include an image tag 138, 148, and 158 referencing a thumbnail image of an image “A” 108 included in the target web page 106. The web pages 134, 144, and 154 are markup language documents, e.g., HyperText Markup Language (HTML) documents. In FIG. 1, the target web page 106 is depicted as having been rendered by a web browser. The target web page 106 includes images “A” 108, “B” 110, and “C” 112.

The example environment 100 includes web servers 102, 130, 140, and 150 coupled to each another through a data communication network 120, e.g., a local area network (LAN) or wide area network (WAN), e.g., the Internet, or a combination of networks. The web servers 102, 130, 140, and 150 are each a computer or multiple computers that run software, e.g., web server software, to provide resources, e.g., web pages, to user devices through the data communication network 120. The web servers 102, 130, 140, and 150 can include, and can communicate with, respective storage devices132, 142, and 152. The storage devices 132, 142, and 152 can store the resources, e.g., the web pages, images, and other documents.

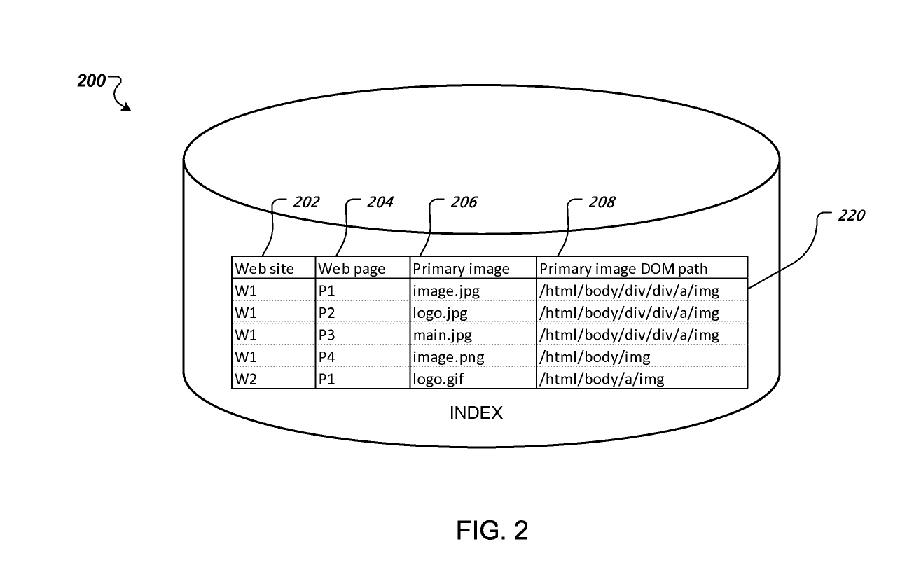

Web pages 106, 134, 144, and 154 can be crawled and indexed by a search system 160. As part of its crawling and indexing of resources, e.g., web resources on the Internet, a search system 160 gathers and stores in its indices, e.g., the index 200 that will be described in reference to FIG. 2, a variety of information about web pages and other addressable resources on the Internet. The system 160 can store the indices in one or more storage devices 162. The system 160 can be implemented on one or more computers operating in one or more locations with the storage devices 162.

The search system 160 gathers and stores, in an index, Uniform Resource Locators (URLs) for web pages 106, 134, 144, and 154, together with data identifying images that are included in the respective web pages 106, 134, 144, and 154. The system 160 identifies images in a web page by identifying image markup language elements, e.g., image tags, included in the markup language of the web page. In HTML documents, “img” tags can specify URLs for images in a web page using a “src” attribute. Thus, for example, if the HTML for a web page includes a tag <img src=“example.jpg”>, the system 160 can identify the image “example.jpg” as an image in the web page. Images that are directly embedded in web pages can also be identified.

The system 160 gathers and stores, in the index, respective object paths for the images identified in a web page. In some implementations, the object path is a Document Object Model (DOM) path that describes the location of the corresponding image in the web page. In other implementations, other kinds of location information are used to specify a path. In the former implementations, the system 160 determines a DOM path for an image using operations provided in a DOM Application Programming Interface (API), e.g., libxml2, MSXML, or Xerces.

In addition, the system 160 can gather and store, in the index, any hyperlinks in the web pages 106, 134, 144, and 154 that both link to another web page and include an image tag for a thumbnail image. The system 160 identifies hyperlinks in a web page by examining hyperlink markup language elements, e.g., anchor tags, included in the web page. Anchor tags can be customized with attributes that specify a hyperlinked resource, e.g., a web page, and an image to be rendered in a web browser as part of the hyperlink. For example, for a web page written in HTML, the system 160 identifies hyperlinks by identifying “a” tags in the web page. The “a” tags can specify URLs for resources, e.g., web pages, using an “href” attribute. Thus, for example, if the HTML for the web page includes a tag <a href=“http://www.example.com/webpage.html”><img src=“image.jpg”></a>, the system 160 identifies the tag as a hyperlink that links to a web page “webpage.html” in a website “www.example.com”. Further, the system 160 determines that the hyperlink includes an image tag for a thumbnail image “image.jpg”.

For example, as illustrated in FIG. 1, the system 160 gathers and stores, in the index, data identifying images 108, 110, and 112 in the target web page 106, hyperlinks 136, 146, and 148 in web pages 134, 144, and 154 that both link to the target web page 106 and include thumbnail image tags 138, 148, and 158 that each reference the image 108 in the target web page 106.

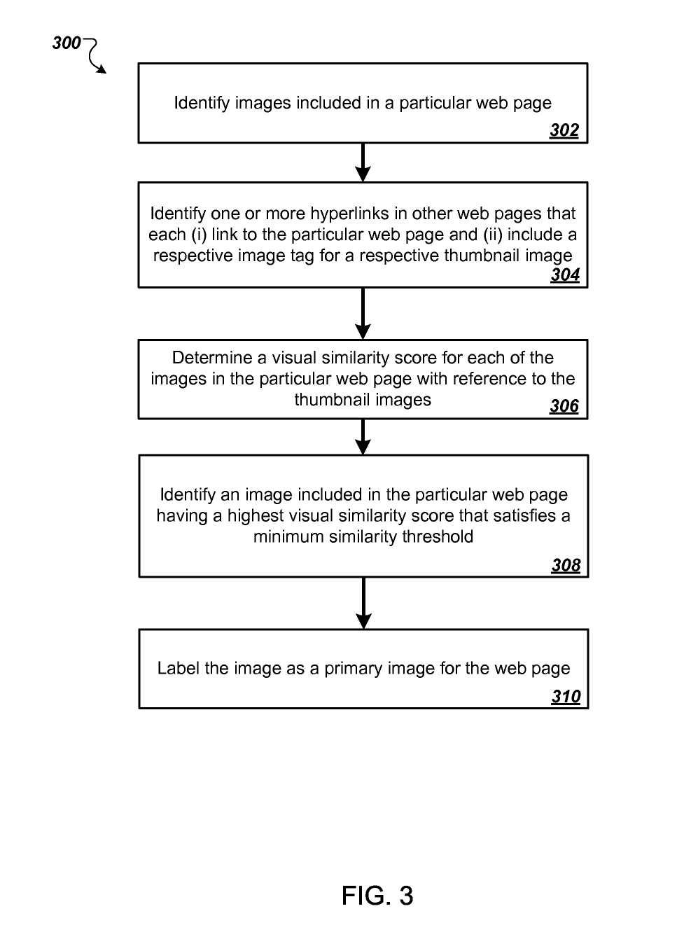

The system 160 identifies primary images for web pages using the process that will be described in reference to FIG. 3. Further, the system 160 can label, in the index, primary images identified for web pages, together with respective object paths for the identified primary images. The labeling can take any convenient form; for example, the system can maintain an index of primary images and, for each primary image, a list of the web pages for which the image is a primary image.

Images identified as primary images for web pages can be used by the search system 160 to rank image search results. An image search result can be, for example, a reference to an image resource that is identified by a search system as satisfying a query, e.g., a text query or an image query. For example, an image search result referencing an image that is visually similar to a primary image for a particular web page can be given a higher rank than image search results referencing images that are not visually similar to any primary image.

FIG. 2 is a block diagram of an example index 200 depicting data that was collected and organized by a search system, e.g., the system 160, while crawling the Internet. In some implementations, the index 200 stores data identifying a web site 202, e.g., a URL, a corresponding web page 204 in the web site 202, a primary image 206 for the web page 204, and an object path 208 of the primary image 206. In FIG. 2, the index 200 is depicted as storing data describing a web page P1 in a website W1, a primary image “image.jpg” for the web page P1, and a primary image DOM path “/html/body/div/div/a/img” for the web page P1. The index 200 is also depicted as storing data describing a web page P2 in the website W1, a primary image “logo.jpg” for the web page P2, and a primary image DOM path “/html/body/div/div/a/img” for the web page P2.

FIG. 3 is a flow diagram of an example process for identifying a primary image in a web page. For convenience, the process 300 will be described as performed by a computer system that can be made up of one or more computers located in one or more locations.

The system identifies images included in a particular web page (302).

The system identifies one or more hyperlinks in other web pages that each (i) link to the particular web page and (ii) include a respective image tag for a respective image, which will be referred to as a thumbnail image (304).

The system determines a visual similarity score for each of the images in the particular web page, which may be referred to as “page images”, with reference to the thumbnail images (306).

In some implementations, as a preliminary step in determining a visual similarity score for an image with reference to the thumbnail images, the system determines whether the thumbnail images are visually similar to each other. In these implementations, if the thumbnail images are not determined to be visually similar to each other, the system determines a visual similarity score for the page image such that the page image will not be identified as a primary image, or simply ends the process for identifying a primary image with respect to the current page image.

Visual similarity between two images can be determined using conventional image analysis techniques, e.g., by detecting and comparing edges in a first and second image or by keypoint matching one or more regions in a first and second image. Visual similarity between two images can be measured using a numeric similarity value, as determined by a similarity function. The similarity value can range from 0.0 to 1.0, where a value of 0.0 indicates that the images are very different, and a value 1.0 indicates that the images are identical. Other ranges of values can also be used.

In some such implementations, the system requires that all thumbnail images be identical. In other implementations, the thumbnail images are required to include no pair of images with a similarity value that is less than a predetermined threshold, e.g., 0.90, 0.95, or 0.98 on a scale of 0.0 to 1.0. The threshold value, which determines whether the system considers two images to be similar or not, can be determined empirically based on evaluations by human raters. In other implementations, all but a predetermined small percentage, e.g., 10%, 5%, or 1%, of the thumbnail images must be identical or within a threshold similarity of each other.

In some implementations, the system determines that two thumbnails are visually similar only if the image tags reference the same resource.

In any of the implementations in which the system determines that the thumbnail images are visually similar to each other, the system determines a visual similarity score for the page image with reference to the thumbnail images. The system can determine a visual similarity score for the image from a similarity value representing the similarity of the page image and one of the visually similar thumbnail images.

In implementations in which the system does not preliminarily determine whether the thumbnail images are visually similar to each other, the system determines a visual similarity score for the page image by determining a respective similarity value for the page image and each of the thumbnail images, which represents the similarity of the pair of images to each other, and using those similarity values to determine the visual similarity score for the page image. Depending on the implementation, the median value of the similarity values, a geometric, arithmetic, or harmonic mean of the similarity values, a lowest similarity value of the similarity values, or other statistic derived from the similarity values can be selected as the visual similarity score for the image.

The system identifies a page image, if there is one, having a highest visual similarity score that also satisfies a minimum similarity threshold (308).

The system labels the page image, if there is one, as a primary image for the web page (310). In some implementations, images identified as primary images are labeled as such in an index, e.g., the index 200 described in reference to FIG. 2.

The technique described above can be applied to videos included in a particular web page to identify a primary video of a web page. In some implementations, the system identifies one or more hyperlinks in other web pages that each (i) link to the particular web page and (ii) include a respective image tag for a respective thumbnail image. The system then identifies a video identified in the particular web page that has a highest similarity visual score that satisfies a visual similarity test with reference to the thumbnail images. In determining whether a visual similarity test is satisfied, the system (i) evaluates a similarity function with (a) a frame, e.g., the first frame, of a video included in the web page and (b) a thumbnail image as arguments to determine a similarity value, and (ii) determines that the similarity value satisfies a similarity threshold. In such implementations, the video with a frame having the highest visual similarity score in comparison to other frames in videos that were identified in the particular web page is identified as a primary video of the particular web page.

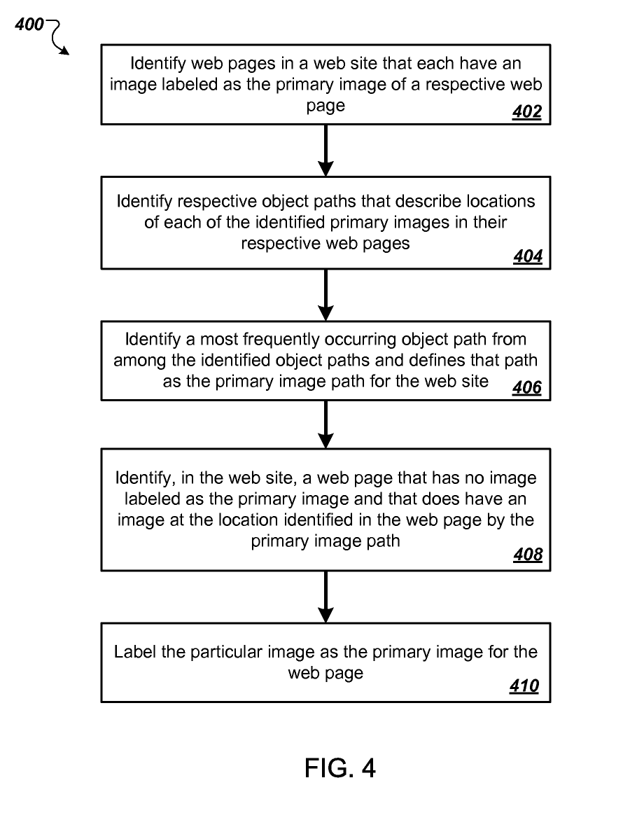

FIG. 4 is a flow diagram of another example process 400 for identifying a primary image in a web page. For convenience, the process 400 will be described as performed by a computer system that can be made up of one or more computers located in one or more locations.

The system identifies web pages in a web site that each have an image labeled as a primary image of a respective web page (402).

The system identifies respective object paths that describe locations of each of the identified primary images (404) in their respective web pages. As noted above, the object paths can be DOM paths. The system can find object paths for the identified primary images in an index, e.g., the index 200 described above in reference to FIG. 2.

The system identifies a most frequently occurring object path from among the identified object paths and defines that path as the primary image path for the web site (406).

In some implementations, a primary image path is defined only when a ratio of the number of occurrences of the most frequently occurring object path and the total number of identified object paths satisfies a predetermined threshold value, e.g., 0.75, 0.8, 0.85, or 0.9 on a scale of 0.0 to 1.0.

The system identifies, in the web site, a web page that has no image labeled as a primary image and that does have an image at the location identified in the web page by the primary image path (408). For example, the system can identify in the web site W1 a web page P5 that has no image labeled as a primary image. The system can also determine whether the web page P5 has a particular image whose location in the web page matches the primary image path “/html/body/div/div/a/img”. If these conditions are satisfied, the system identifies the particular image as the primary image for the web page P5.

The system labels the particular image as the primary image for the web page (410). In some implementations, the system identifies the particular image as a primary image for the web page in an index, e.g., the index 200 described in reference to FIG. 2.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, the method comprising:
identifying a plurality of web page images in a target web page;
identifying a plurality of hyperlinks in other web pages, wherein each of the hyperlinks (i) links to the target web page and (ii) includes a respective image tag for a respective thumbnail image;
determining a visual similarity score for each of the plurality of web page images with reference to the thumbnail images;
identifying a first web page image in the plurality of web page images that has a highest visual similarity score with reference to the thumbnail images that satisfies a minimum similarity threshold; and
labeling the first web page image as a primary image for the target web page.

2. The method of claim 1, wherein determining a visual similarity score for each of the plurality of web page images with reference to the thumbnail images comprises:
determining for each web page image a similarity value with respect to each thumbnail image, wherein the similarity value represents a degree of visual similarity between the web page image and the thumbnail image; and
determining the visual similarity score for the web page image from the similarity values for the web page image.

3. The method of claim 2, wherein determining the visual similarity score for the web page image from the similarity values for the web page image with reference to the thumbnail images comprises:
selecting as the visual similarity score a median value of the similarity values, a mean of the similarity values, or a lowest similarity value of the similarity values.

4. The method of claim 1, further comprising:
determining that the thumbnail images are all visually similar to each other.

5. The method of claim 4, further comprising:
determining that the thumbnail images are all identical;
wherein determining a visual similarity score for each of the plurality of web page images with reference to the thumbnail images comprises:
determining, for each web page image, a value of a visual similarity function applied to the web page image and one of the thumbnail images.

6. The method of claim 4, wherein determining that the thumbnail images are all visually similar to each other comprises determining that all of thumbnail images are identical to one another.

7. The method of claim 4, wherein determining that the thumbnail images are all visually similar to each other comprises determining that none of the respective similarity values corresponding to the thumbnail images are less than a predetermined threshold.

8. The method of claim 4, wherein determining that the thumbnail images are all visually similar to each other comprises determining that all but a predetermined percentage of the thumbnail images are identical to one another.

9. The method of claim 4, wherein determining that the thumbnail images are all visually similar to each other comprises determining that all but a predetermined percentage of the thumbnail images are within a threshold similarity of each other.

10. A computer-implemented method, the method comprising:
identifying in a web site a plurality of web pages that each have an image labeled as the primary image of the respective web page;
identifying a respective object path of each of the primary images, each object path being a Document Object Model path that defines a location of the corresponding primary image in the respective web page;
defining a most frequently occurring object path among the identified object paths as the primary image path for the web site;
identifying in the web site a first web page that has no image labeled as the primary image of the first web page and that does have a first image identified in the first web page by the primary image path; and
labeling the first image as the primary image for the first web page.

11. The method of claim 10, wherein labeling the first image as the primary image for the first web page comprises identifying, in an index, the first image as a primary image for the first web page.

12. The method of claim 10, wherein defining a most frequently occurring object path among the identified object paths as the primary image path for the web site comprises identifying an object path that occurs more frequently than the other identified object paths combined.

13. The method of claim 10, wherein defining a most frequently occurring object path among the identified object paths as the primary image path for the web site comprises identifying an object path that occurs with at least a predetermined threshold frequency.

14. A system comprising:
one or more computers and one or more storage devices storing instructions that are operable, when executed by the one or more computers, to cause the one or more computers to perform operations comprising:
identifying a plurality of web page images in a target web page;
identifying a plurality of hyperlinks in other web pages, wherein each of the hyperlinks (i) links to the target web page and (ii) includes a respective image tag for a respective thumbnail image;
determining a visual similarity score for each of the plurality of web page images with reference to the thumbnail images;
identifying a first web page image in the plurality of web page images that has a highest visual similarity score with reference to the thumbnail images that satisfies a minimum similarity threshold; and
labeling the first web page image as a primary image for the target web page.

15. The system of claim 14, wherein determining a visual similarity score for each of the plurality of web page images with reference to the thumbnail images comprises:
determining for each web page image a similarity value with respect to each thumbnail image, wherein the similarity value represents a degree of visual similarity between the web page image and the thumbnail image; and
determining the visual similarity score for the web page image from the similarity values for the web page image.

16. The system of claim 15, wherein determining the visual similarity score for the web page image from the similarity values for the web page image with reference to the thumbnail images comprises:
selecting as the visual similarity score a median value of the similarity values, a mean of the similarity values, or a lowest similarity value of the similarity values.

17. The system of claim 14, wherein the operations further comprise:
determining that the thumbnail images are all visually similar to each other.

18. The system of claim 17, wherein the operations further comprise:
determining that the thumbnail images are all identical;
wherein determining a visual similarity score for each of the plurality of web page images with reference to the thumbnail images comprises:
determining, for each web page image, a value of a visual similarity function applied to the web page image and one of the thumbnail images.

19. The system of claim 17, wherein determining that the thumbnail images are all visually similar to each other comprises determining that all of thumbnail images are identical to one another.

20. The system of claim 17, wherein determining that the thumbnail images are all visually similar to each other comprises determining that none of the respective similarity values corresponding to the thumbnail images are less than a predetermined threshold.
